(19) United States
(12) Patent Application Publication
(10) Pub. No.: US 2013/0019956 A1
(43) Pub. Date: Jan. 24, 2013

(54) CONSTANT FLOW RATE FLUID CONTROLLER

(71) Applicants: Russell L. Hallman, JR., Knoxville, TN (US); Paul D. Vanatta, Oak Ridge, TN (US); Michael J. Renner, Oak Ridge, TN (US)

(72) Inventors: Russell L. Hallman, JR., Knoxville, TN (US); Paul D. Vanatta, Oak Ridge, TN (US); Michael J. Renner, Oak Ridge, TN (US)

(73) Assignee: BABCOCK & WILCOX TECHNICAL SERVICES Y-12, LLC, Oak Ridge, TN (US)

(21) Appl. No.: 13/188,612

(22) Filed: Jul. 22, 2011

(51) Int. Cl. F15D 1/00

(52) U.S. Cl. 137/14; 137/565.29

(57) ABSTRACT

An apparatus and method is provided for establishing a constant flow rate of a fluid, such as a gas or a liquid, into a process system. The apparatus typically includes a fluid pressure regulator, a rotameter, and a back pressure regulator. The system may also include a throttle valve. Establishing a constant flow rate involves established a fixed pressure drop across a fixed flow resistance device, such as a rotameter. The pressure of the output of the rotameter is adjusted to be higher than the backpressure from the process system.

### GOVERNMENT RIGHTS

The U.S. Government has rights to this invention pursuant to contract number DE-AC05-000R22800 between the U.S. Department of Energy and Babcock & Wilcox Technical Services Y-12, LLC.

### FIELD

This disclosure relates to the field of fluid control systems. More particularly, this disclosure relates to fluid flow rate controllers.

### BACKGROUND

Many process systems require a constant flow rate of a process fluid. If operation of the process does not cause a variation in the fluid pressure at the point of delivery of the process fluid into the process system, then simply providing the process fluid at a constant input pressure will result in a constant flow rate of fluid into the process. However, the operation of many process systems is often more complicated. For example, in many systems the operation of the process causes a variation in the fluid pressure at the input of the process. The fluid pressure at the input of a process is the “opposing resistive pressure” experienced by the system providing the process fluid. A variation in fluid pressure at the input of a process may occur because of changes in process temperature, changes in volume, changes due to chemical reactions, changes initiated by internal process fluid regulators, or similar variations in processing operations. Without a system to regulate the flow of fluid into a process, if the fluid pressure at the input (i.e., the backpressure experienced by the source of the process fluid) increases then the flow rate of process fluid into the process system will typically decrease, and if the fluid pressure at the input (i.e., the backpressure experienced by the source of process fluid) decreases then the flow rate of process fluid into the process system will increase. These fluctuations may be controlled by such methods as monitoring the flow and employing an electronic flow controller that opens or closes a throttle valve to deliver a constant flow rate of needed process fluid as down-stream conditions change. Such systems are somewhat complicated and furthermore, in process applications that involve the use of combustible materials, the use of an electronic flow control mechanism is not advisable due to a possibility of triggering a fire or an explosion. What are needed therefore are simple systems for providing a constant flow of process fluid to a process system.

### SUMMARY

Disclosed herein are methods of providing a constant flow rate of a process fluid to a process system, where the process system has an opposing resistive pressure. The methods typically involve providing the process fluid to a fixed flow resistance at a fixed inlet pressure and flowing the process fluid through the fixed flow resistance while establishing a constant outlet pressure from the fixed flow resistance that is higher than the opposing resistive pressure of the process system. The method further includes a step of flowing the process fluid from the fixed flow resistance to the process system.

Also disclosed herein are apparatuses for providing a constant flow rate of process fluid to a process system having an opposing resistive pressure. The apparatuses typically include a source of the process fluid and a fixed flow resistance device having an inlet and an outlet. Generally a pressure regulator is disposed between the source of the process fluid and the fixed flow resistance device, to set a first pressure of the process fluid at the inlet of the fixed flow resistance device. Also generally included is a back pressure regulator to set a second pressure of the process fluid at the outlet of the fixed flow resistance device. A process line is typically used to provide the constant flow rate of the process fluid to the process system.

Also disclosed here are systems for providing a constant flow rate of a blend of process fluids to a fluid mixer, where the fluid mixer has a first opposing resistive pressure and a second opposing resistive pressure. Such systems typically provide a first source of a first process fluid, and there is a first fixed flow resistance device having a first inlet and a first outlet. A first pressure regulator is generally disposed between the first source of the first process fluid and the first fixed flow resistance device, to set a first pressure of the first process fluid at the first inlet. A first back pressure regulator is typically used to set a second pressure of the first process fluid at the first outlet to a first supply pressure that is greater than the first opposing resistive pressure, and a first constant flow rate of the first process fluid is established. A first process fluid feed line may be used to provide the first constant flow rate of the first process fluid from the first back pressure regulator to the fluid mixer. Such systems typically provide a second source of a second process fluid and there is a second fixed flow resistance device having a second inlet and a second outlet. A second pressure regulator is typically disposed between the second source of the second process fluid and the second fixed flow resistance device, to set a first pressure of the second process fluid at the second inlet. A second back pressure regulator is generally provided to set a second pressure of the second process fluid at the second outlet to a second supply pressure that is greater than the second opposing resistive pressure, and a second constant flow rate of the second process fluid is established. A second process fluid feed line may be used to provide the second constant flow rate of the second process fluid from the second back pressure regulator to the fluid mixer.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a process schematic for an embodiment of a system for providing a constant flow rate of a process fluid to a process system.

FIG. 2 is a process schematic for an embodiment of a system for providing a regulated flow rate of a process fluid to a process system.

FIG. 3 is a process schematic for an embodiment of a system for providing a constant flow rate of a blend of process fluids to a process system.

### DETAILED DESCRIPTION

In the following detailed description of the preferred and other embodiments, reference is made to the accompanying drawings, which form a part hereof, and within which are shown by way of illustration the practice of specific embodiments of methods and systems for providing a constant (and in some embodiments a regulated) flow rate of a process fluid to a process system having an opposing resistive pressure. It is to be understood that other embodiments may be utilized, and that structural changes may be made and processes may vary in other embodiments. It is to be understood that the term “regulated” flow rate as used herein refers to a “constant” flow rate that is adjustable. In other words, the flow rate through a system for providing a “regulated” flow rate is constant until an adjustment is made to the system that changes the flow rate to a new constant value. The term “constant flow rate” refers to a flow rate that may or may not be adjustable.

Methods and systems for providing a constant flow rate of process fluid (either a gas or a liquid) may be provided by the use of a fixed flow resistance device in combination with a pressure regulator and a back pressure regulator. Non-electrical methods and systems may be employed and are referred to as “intrinsically safe” because there is no electrical component that could generate a spark to ignite combustible or explosive materials. In intrinsically safe embodiments energy only from fluid pressures and from mechanical devices such as springs is typically employed to drive mechanical devices, instead of using any electrical energy for such purposes.

The term “fixed” as used herein refers to a set value. The fixed value may be either permanently established by an unadjustable hardware configuration of the device or the fixed value may be adjustably established by modifying a feature of the hardware. Consequently a “fixed flow resistance device” is a device that has a flow resistance value that is either permanently established by the configuration of the device, or that may be adjusted by altering the configuration of a mechanism provided by the device to change the flow resistance. A fixed flow resistance device that is adjustable may be used to provide a regulated flow rate of a process fluid.

A rotameter may be used as the fixed flow resistance device. A rotameter is a gauge for measuring the flow rate of a fluid, and a rotameter typically provides an unadjustable fixed flow resistance. A rotameter has an inlet and an outlet, and typically includes a graduated glass tube containing a free-floating ball that moves up or down to indicate more or less fluid flow into the inlet, through the glass tube, and out the outlet. The ball provides a small resistance to the flow of fluid through the rotameter. A rotameter is a useful fixed flow resistance device because it has only a small internal flow resistance and because it provides a convenient visual indication of the flow rate of fluid through the device.

In an operation where there is a pressure drop across a rotameter, if the difference between the inlet and outlet fluid pressures for a rotameter increases, then comparatively more fluid flows through the rotameter and the ball moves up in the glass tube to indicate that increase in the flow rate. If the difference between the inlet and outlet fluid pressures for a rotameter decreases, then comparatively less fluid flows through the rotameter and the ball moves down in the glass tube to indicate that decrease in the flow rate. If the pressure difference remains constant between the inlet and outlet of the rotameter, then the ball stays at a constant elevation in the glass tube to indicate a constant flow rate. To look at the operation of a rotameter from another perspective, the flow rate may be held constant through a rotameter if the difference between the inlet and the outlet pressures of the rotameter inlet is held constant. A constant difference in pressure may be achieved by holding the inlet pressure constant and holding the outlet pressure constant.

It is comparatively easy to control the supply pressure to a fixed flow resistance device (such as a rotameter) by using a conventional pressure regulator to provide the process fluid supply to the fixed flow resistance device at a fixed inlet pressure. The term “fixed inlet pressure” refers to a fluid pressure at the inlet that is either permanently (unadjustably) established by the configuration of hardware in the system, or to a fluid pressure at the inlet that may be adjusted by altering the configuration of a mechanism provided by the hardware in the system to change the inlet pressure. However, a fixed inlet pressure does not by itself ensure that process fluid that is provided to a process system from the outlet of the fixed flow resistance device will be at a fixed pressure when the fluid arrives at the process system. If the outlet of the fixed flow resistance device is connected directly to the input of a process system, then any changes in the fluid pressure at the input of the process system changes the pressure back upstream at the outlet of the fixed flow resistance device. Such changes in the fluid pressure at the input of the process system may be due to temperature changes within the chemical process, or due to changes in chemical reactions occurring within the process system, or due to changes initiated by process fluid regulators internal to the process system, or due to other factors that change the fluid flow resistance of the process system. That pressure change at the outlet of the fixed flow resistance device changes the flow rate of process fluid through the fixed flow resistance device, and therefore changes the flow rate of process fluid being fed to the process system. That is, without some mechanism to correct for variations in pressure across the fixed flow resistance device, the flow rate of process fluid to the process system varies.

This undesired change in flow rate may be remedied by holding the pressure constant at the outlet of the fixed flow device. For example, back pressure regulation, such as provided by a device such as a dome-loaded back pressure regulator or a spring-loaded back pressure regulator, may be used to maintain a constant pressure at the outlet of the fixed flow rate device. Establishing a fixed inlet pressure and a fixed outlet pressure for a fixed flow resistance device ensures that a constant flow rate of process fluid flows through the fixed flow resistance device. If all of the process fluid flowing through the fixed flow resistance device is provided to a process system, then the process system receives the same constant flow rate of process fluid. Such flow occurs provided that fluid pressure at the outlet of the fixed flow resistance device exceeds the opposing resistive pressure (backpressure) generated by that process system. Otherwise there is insufficient pressure force to cause the process fluid to flow into the process system. In some embodiments the opposing resistive pressure generated by the process system may be zero or substantially zero, measured as a “gauge pressure” (i.e., measured relative to ambient atmospheric pressure). In some embodiments the opposing resistive pressure generated by the process system may be a negative gauge pressure, such as a partial vacuum or a substantially complete vacuum.

As previously noted, the opposing resistive fluid pressure at the input of the process system typically fluctuates as the process operates. However, for any process system there will generally be a known upper limit to the opposing resistive pressure generated by that process system. For fluid to consistently and reliably flow from the outlet of the fixed flow rate device into the process system the outlet pressure from the fixed flow rate device must exceed the upper limit of the opposing resistive pressure of the process system. To ensure that this pressure difference is reliably maintained it is best to set the back pressure regulator to maintain the outlet pressure of the fixed flow resistance device at a pressure level that is well in excess of the upper limit of opposing resistive pressure that may occur in the process system, plus any pressure drop through the process line from the fixed flow resistance device to the process system. This ensures that the process fluid supply system overwhelms the internal resistance of the process system and produces a constant process fluid flow rate.

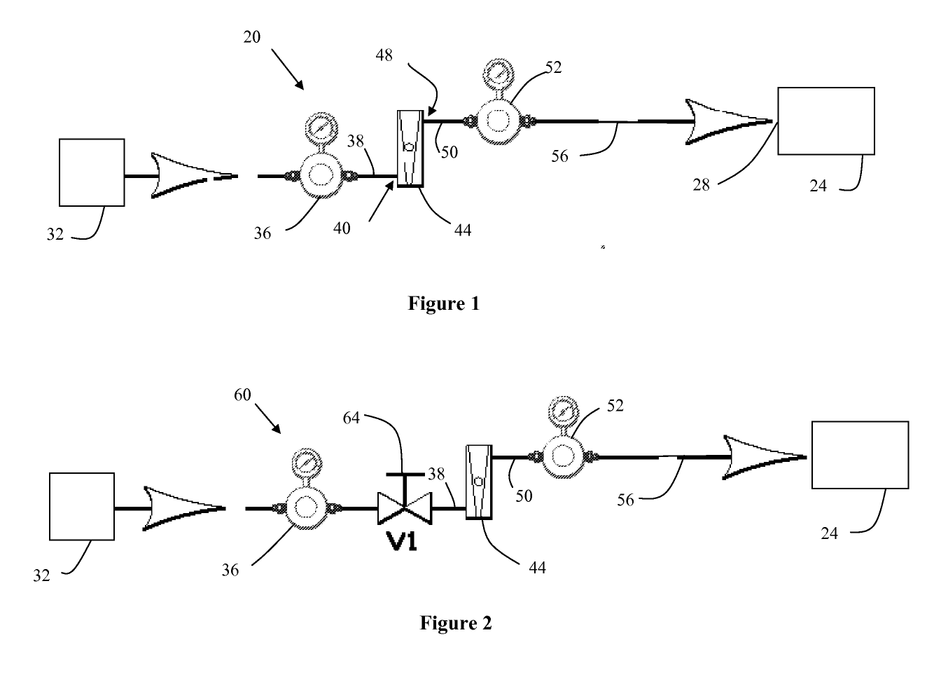

FIG. 1 illustrates a sample embodiment of an apparatus 20 for providing a constant flow rate of a process fluid to a process system 24. The process system 24 has an opposing resistive pressure at the input 28 of the process system 24. The opposing resistive pressure at the input 28 of the process system 24 may vary over time, but as previously noted, the opposing resistive pressure of a process system typically has a known upper limit. A process fluid source 32 feeds a pressure regulator 36. The output of the pressure regulator 36 provides a process fluid through a first process fluid line 38 to the inlet 40 of a rotameter 44. The rotameter 44 is a fixed flow resistance device and provides a fixed flow resistance to the process fluid as the process fluid flows through the rotameter 44 and out the outlet 48 of the rotameter 44 through a second process fluid line 50. While in the embodiment of FIG. 1 the rotameter provides the fixed flow resistance, in other embodiments an impermeable capillary tube or a metering needle valve, or a thin-plate orifice, may be used between the first process fluid line 38 and the second process fluid line 50 in place of the rotameter 44 to provide the fixed flow resistance. The term “thin-plate orifice” refers to an industry-standard thin-plate orifice that is typically installed between the flanges of a tube joint. The term “thin-plate orifice” also includes a comparable orifice that may, for example, be drilled through the end wall of a customized union blank coupling, in which case there is no “plate” per se. An impermeable capillary tube, a thin-plate orifice, or a rotameter provides an unadjustable fixed flow resistance whereas a metering needle valve provides an adjustable fixed flow resistance. The amount of flow resistance is not critical, but it needs to be large enough so that the resistance is discernable but small enough to not significantly impede the flow of process fluid through the apparatus 20. Typically the fixed flow resistance results in a pressure drop across the fixed flow resistance device that is in a range from 2 to 5 pounds per square inch.

In the embodiment of FIG. 1 a back pressure regulator 52 fixes the outlet pressure of the device that provides the fixed flow resistance (i.e., the rotameter 44 in this embodiment). The fixed outlet pressure is set by the back pressure regulator 52 to a supply pressure that is greater than the opposing resistive pressure at the input 28 of the process system 24. As previously noted, it is advisable to set the fixed outlet pressure to a supply pressure that is greater than the upper limit of the opposing resistive pressure at the input 28 of the process system 24, so that a constant flow of the process fluid is provided under all operating conditions of the process system 24. An output process fluid feed line 56 then supplies a constant flow rate of process fluid to the process system 24. The process fluid flows from the process fluid source 32 through the pressure regulator 36, through the rotameter 44, through the back pressure regulator 52, through the output process fluid feed line 56, into the process system 24. The flow rate through the apparatus 20 is a function of three variables, (1) the process fluid supply pressure, which is set by the pressure regulator 36, (2) the resistance of the rotameter 44, which is established by the design of the device, and (3) the outlet pressure from the rotameter 44, which is set by the back pressure regulator 52.

FIG. 2 illustrates a sample embodiment of an apparatus 60 for providing a regulated flow rate of a process fluid to a process system 24. The components of the apparatus 60 are the same as the components of the apparatus 20 of FIG. 1, except that a throttle valve 64 has been added between the pressure regulator 36 and the rotameter 44. The throttle valve 64 may be used for adjustably flowing process fluid through the rotameter 44. An adjustment of the pressure setting of the pressure regulator 36 or the pressure setting of the back pressure regulator 52 may also be used to adjust the process fluid flow rate through the apparatus 60 (or through the apparatus 20 of FIG. 1). However, the throttle valve 64 is a simpler mechanism to provide for adjustably flowing process fluid to the process system without changing either of those pressures.

The flow of process fluid through apparatus 20 or apparatus 60 is analogous to an electrical circuit. In a DC electrical circuit the voltage or potential difference is represented as V, the resistance is represented by R, and the current flow is represented by I. The governing equation is Equation 1:

V=I·R (Eq'n 1)

Per Equation 1, the voltage is equal to the current times the resistance. An analogous equation may be formulated for the apparatus 20 or the apparatus 60. The equation is Equation 2:

ΔP=Fr·R (Eq'n 2)

where ΔP is the pressure difference, Fr is the flow rate, and R is resistance. ΔP of Equation 2 is equivalent to the voltage V of Equation 1, both being a difference of forcing potential. Fr of Equation 2 is equivalent to the current, I, of Equation 1, both being flow rates. The R of Equation 1 and 2 are resistances to flow, i.e., resistance to current flow in Equation 1 and resistance to fluid flow in Equation 2.

From Equation 2, the flow rate (Fr) is constant for a fixed potential (ΔP) and fixed flow resistance (R). To reduce the flow rate (Fr) while maintaining a constant pressure difference ΔP the resistance (R) may be increased. To increase the flow rate (Fr) while maintaining a constant pressure difference ΔP the resistance (R) may be decreased. The throttle valve 64 of the apparatus 60 may be adjusted toward fully closed or may be adjusted toward fully open in order to provide such an increase or decrease in flow rate, respectively.

The apparatus 20 of FIG. 1 and the apparatus 60 of FIG. 2 provide flow control without the use of electricity. These or similar apparatuses may be used to provide flow rate control in potentially explosive environments, or in remote processing areas where electricity is unavailable or intermittent. In process systems that work best when operating parameters are held constant, these or similar apparatuses may be utilized to nullify process perturbations. In most electrical devices there is a lag in response between a sensed flow change and the corrective action by the controller. In contrast, tests have shown that the response of embodiments of apparatus 20 and apparatus 60 is almost instantaneous. These non-electrical devices may be adjusted to a new desired flow rate with almost instantaneous response and with no loss of system control.

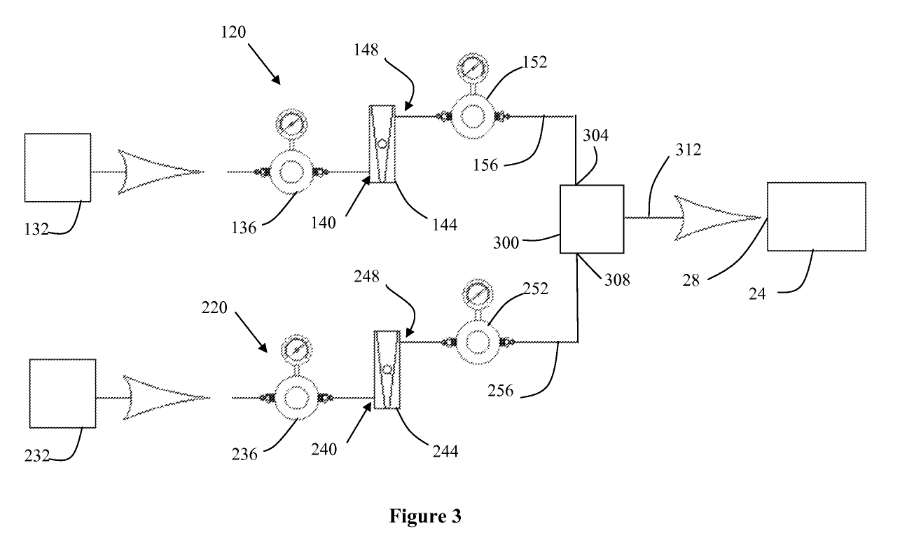

As illustrated in FIG. 3, two apparatuses (in this case, two apparatuses equivalent to apparatus 20 of FIG. 1) may be operated in parallel to supply a blend of two process fluids at a constant flow rate to a process system. In other embodiments two apparatuses equivalent to apparatus 60 of FIG. 2 may be used (or a combination of an apparatus equivalent to apparatus 20 of FIG. 1 and an apparatus 60 of FIG. 2 may be used) to supply a blend of two process fluids at a constant flow rate to a process system. More than two such apparatuses may be operated in parallel to provide further blending. In the embodiment of FIG. 3 a first apparatus 120 provides a source of a first process fluid 132, and a second apparatus 220 provides a source of a second process fluid 232. The elements of the first apparatus 120 correspond to the elements of the apparatus 20 of FIG. 1, with the element numbers being prefaced with the digit “1,” and the elements of the second apparatus 220 correspond to the elements of the apparatus 20 of FIG. 1 with the element numbers being prefaced with the digit “2.” A first output process fluid feed line 156 of the first apparatus 120 and a second output process fluid feed line 256 of the second apparatus 220 feed a fluid mixer 300 where the first process fluid and the second process fluid are blended. The fluid mixer 300 may be a passive device such as a plenum or simply a “T” connection, or the fluid mixer 300 may be an active device that includes a rotating element (such as a fan blade) to mix the fluids. The fluid mixer 300 has a first opposing resistive pressure at the first input 304 and a second opposing resistive pressure at the second input 308. In some embodiments the first opposing resistive pressure may be equal to the second opposing resistive pressure. In a blending system such as depicted in FIG. 3, a first back pressure regulator (e.g., the backpressure regulator 152) is used to set a first fluid pressure of the first process fluid at the first fixed flow resistance device outlet 148 of the first fixed flow resistance device 144 to a first supply pressure that is greater than the first resistive pressure of the fluid mixer 300. Then a second back pressure regulator (e.g., the backpressure regulator 252) is used to set a second fluid pressure of the second process fluid at the second fixed flow resistance device outlet 248 of the second fixed flow resistance device 244 to a second supply pressure that is greater than the second resistive pressure of the fluid mixer 300. A blended process fluid feed line 312 provides a constant flow rate of the blended process fluid from the mixer 300 to the process system 24.

An initial prototype was built for use with gases such as air, argon, nitrogen, etc. However, the same concept may be used for other fluids such as liquids. Other adaptations are also possible. For example, a system with a low supply pressure may incorporate a pump to generate sufficient pressure for the control method. This pump would likely be used to feed process fluid to the supply pressure regulator. For example, ambient air may be used as a process fluid source if its pressure is increased using a pump. In applications where it is desirable or necessary to avoid the use of electricity, such as for intrinsically safe systems, the pump may be a booster pump driven by a high-pressure fluid supply. If a fluid source at constant pressure is available, such as from a regulated process line, the supply regulator may be eliminated and only the throttle valve and/or rotameter and back pressure control valve may be required.

In summary, embodiments disclosed herein provide methods and apparatuses for providing a constant flow rate of process fluid to a process system having an opposing resistive pressure. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A method of providing a constant flow rate of process fluid to a process system having an opposing resistive pressure, comprising
(a) providing the process fluid to a fixed flow resistance device at a fixed inlet pressure, the fixed flow resistance device being selected from the group consisting of a rotameter, an impermeable capillary tube, a metering needle valve and a thin-plate orifice;
(b) flowing the process fluid through the fixed flow resistance device;
(c) fixing an outlet pressure of the fixed flow resistance device to a supply pressure greater than the opposing resistive pressure of the process system wherein the constant flow rate of the process fluid is established; and
(d) flowing the process fluid from the fixed flow resistance device to the process system.

2. The method of claim 1 wherein step (c) comprises using back pressure regulation for fixing the outlet pressure of the fixed flow resistance device.

3. The method of claim 1 wherein steps (a), (b), (c), and (d) use energy only from fluid pressures and from mechanical devices to perform the steps.

4. An apparatus for providing a constant flow rate of process fluid to a process system having an opposing resistive pressure, comprising
a source of the process fluid;
a fixed flow resistance device having an inlet and an outlet, the fixed flow resistance device being selected from the group consisting of a rotameter, an impermeable capillary tube, a metering needle valve and a thin-plate orifice;
a pressure regulator disposed between the source of the process fluid and the fixed flow resistance device, to set a first pressure of the process fluid at the inlet of the fixed flow resistance device;
a back pressure regulator to set a second pressure of the process fluid at the outlet of the fixed flow resistance device to a supply pressure greater than the opposing resistive pressure wherein the constant flow rate of the process fluid is established; and
a process fluid feed line to provide the constant flow rate of the process fluid from the back pressure regulator to the process system.

5. The apparatus of claim 4 further comprising a throttle valve disposed between the pressure regulator and the fixed flow resistance device.

6. The apparatus of claim 4 further comprising a pump disposed between the source of the process fluid and the pressure regulator.

7. A system for providing a constant flow rate of a blend of process fluids to a fluid mixer having a first opposing resistive pressure and a second opposing resistive pressure, comprising:
a first source of a first process fluid;
a first fixed flow resistance device having a first inlet and a first outlet, the first fixed flow resistance device being selected from the group consisting of a rotameter, an impermeable capillary tube, a metering needle valve and a thin-plate orifice;
a first pressure regulator disposed between the first source of the first process fluid and the first fixed flow resistance device, to set a first pressure of the first process fluid at the first inlet;
a first back pressure regulator to set a second pressure of the first process fluid at the first outlet to a first supply pressure greater than the first opposing resistive pressure, wherein a first constant flow rate of the first process fluid is established;
a first process fluid feed line to provide the first constant flow rate of the first process fluid from the first back pressure regulator to the fluid mixer;
a second source of a second process fluid;
a second fixed flow resistance device having a second inlet and a second outlet, the second fixed flow resistance device being selected from the group consisting of a rotameter, an impermeable capillary tube, a metering needle valve and a thin-plate orifice;
a second pressure regulator disposed between the second source of the second process fluid and the second fixed flow resistance device, to set a first pressure of the second process fluid at the second inlet;
a second back pressure regulator to set a second pressure of the second process fluid at the second outlet to a second supply pressure greater than the second opposing resistive pressure, wherein a second constant flow rate of the second process fluid is established; and
a second process fluid feed line to provide the second constant flow rate of the second process fluid from the second back pressure regulator to the fluid mixer.

8. The apparatus of claim 7 further comprising,
a first throttle valve disposed between the first pressure regulator and the first fixed flow resistance device; and
a second throttle valve disposed between the second pressure regulator and the second fixed flow resistance device.

9. The apparatus of claim 7 further comprising,
a first pump disposed between the first source of the first process fluid and the first pressure regulator; and
a second pump disposed between the second source of the second process fluid and the second pressure regulator.
